(19) United States
(12) Patent Application Publication
(10) Pub. No.: US 2025/0083711 A1
(43) Pub. Date: Mar. 13, 2025

(54) HYBRID LOCOMOTIVE PROPULSION SYSTEM

(71) Applicant: Progress Rail Locomotive Inc., LaGrange, IL (US)

(72) Inventor: Keith Wait, Flower Mound, TX (US)

(73) Assignee: Progress Rail Locomotive Inc., LaGrange, IL (US)

(21) Appl. No.: 18/463,924

(22) Filed: Sep. 8, 2023

(51) Int. Cl. B61C 7/04

(52) U.S. Cl. CPC B61C 7/04

(57) ABSTRACT

A hybrid propulsion system for a locomotive is disclosed. The hybrid propulsion system comprises: ground engaging elements associated with the locomotive; a prime mover for powering propulsion of the ground engaging elements; a traction motor associated with the ground engaging elements; a battery associated with the traction motor; and a controller. The controller includes a route dataset having a topography of a route of the locomotive. The controller is configured to: analyze the topography of the route and location of the locomotive; identify when the locomotive enters a geofence area; and activate a boost mode to discharge an electric energy stored in the battery to the traction motor to boost a tractive force of the ground engaging elements.

### TECHNICAL FIELD

The present disclosure relates to power supplies for locomotives, and more specifically relates to a hybrid propulsion system and a method of boosting power supplied to a train.

### BACKGROUND

A locomotive consist is the arrangement and organization of multiple locomotives that work together, typically within a train. These locomotives may be connected in a specific order to provide the necessary power and traction to move the train efficiently, especially when handling heavy loads or traveling through challenging terrain.

A locomotive consist typically includes a lead locomotive, which is at the front of the train, and one or more trailing locomotives positioned behind it. The lead locomotive is responsible for controlling the train's movement, receiving signals from the train crew, and providing power to the train's systems. Trailing locomotives in the consist provide additional traction and power, especially on steep gradients or in situations where the train is very long or heavy. The arrangement and number of locomotives in a consist is typically assigned based on factors such as the train's weight, length, the type of terrain it will traverse, and the resulting power requirements.

For a train to successfully traverse a route, the train must be provided with sufficient locomotives such that the train's overall power-to-weight ratio (i.e. horsepower-per-ton) exceeds the ruling grade. Unlike conventional diesel-electric locomotives, hybrid locomotives have a standard, diesel-burning prime mover as well as a battery that stores available electric energy. The battery energy can be used instead of, or in addition to, the prime mover to offset fuel consumption and reduce carbon emissions. When the electric energy battery is discharged at the same time the prime mover consumes fuel, the hybrid locomotive can achieve additional power beyond what the prime mover provides.

Grade resistance is calculated as: F_{g}=20·g·W, where W is the weight of the train in tons, g is the grade in percent, and Fg is the resistance due to the grade, or equivalently, the tractive force required to traverse the grade in pounds. The power needed to traverse this grade is found by multiplying the grade force by some speed (typically a reduced speed of 10 mph) and converting to horsepower.

The tractive power achievable by the locomotive while running the prime mover is operating is often referred to as continuous rated power. This level of power is available so long as the locomotive has fuel available. The tractive power achievable by the locomotive while running the prime mover and discharging the battery is often referred to as its peak rated power. Tractive power is available while the batteries have some charge remaining.

Others have attempted to provide locomotives with a battery but have failed to provide a battery boost mode to enable the locomotive consist to traverse areas it otherwise could not. For example, US Patent Pub. No. 2018/0334177 discloses a hybrid power system for a locomotive for transmitting power from a battery to the wheels. However, the system falls short in identifying and efficiently using electric energy stored in a battery while the locomotive consist is in route to a destination.

Hence, there exists a need for a propulsion system that provides enhanced accuracy, efficiency, automation, and integration of electric battery energy to locomotives that can enable a boost mode for the locomotive consist to traverse an area along the route with fewer locomotive units in the consist.

### SUMMARY

In accordance with one aspect of the disclosure, a hybrid propulsion system for a locomotive is disclosed. The hybrid propulsion system comprises: ground engaging elements associated with the locomotive; a prime mover for powering propulsion of the ground engaging elements; a traction motor associated with the ground engaging elements; a battery associated with the traction motor; and a controller. The controller includes a route dataset having a topography of a route of the locomotive. The controller is configured to: analyze the topography of the route and location of the locomotive; identify when the locomotive enters a geofence area; and activate a boost mode to discharge an electric energy stored in the battery to the traction motor to boost a tractive force of the ground engaging elements.

In accordance with another aspect of the disclosure, a hybrid locomotive is disclosed comprising: a frame; ground engaging elements supporting the frame; a prime mover for powering propulsion of the ground engaging elements, the prime mover mounted in the frame; a battery associated with the prime mover and mounted in the frame; and a controller including a route dataset having a topography of a route of the hybrid locomotive. The controller is configured to: analyze the topography of the route and location of the hybrid locomotive; identify when the hybrid locomotive enters a geofence area; and activate a boost mode to discharge an electric energy stored in the battery to the traction motor to boost a tractive force of the ground engaging elements.

In accordance with another aspect of the disclosure, a method for hybrid propulsion of a locomotive is disclosed. The method comprises: providing the locomotive with a frame, ground engaging elements supporting the frame, a prime mover for powering propulsion of the ground engaging elements, a traction motor associated with the ground engaging elements, a battery associated with the traction motor, and a controller in communication with the prime mover, the battery, and the traction motor; analyzing, via the controller, a route dataset provided in the controller, the route dataset having the topography of the route of the locomotive provided in the controller; identifying, via the controller, when the locomotive enters a geofence area; and activating, via the controller, a boost mode to discharge an electric energy stored in the battery, the electric energy provided to the traction motor and converted to mechanical energy to boost a tractive force of the ground engaging elements.

These and other aspects and features of the present disclosure will be better understood upon reading the following detailed description when read in conjunction with the accompanying drawings.

### BRIEF DESCRIPTION OF THE DRAWINGS

FIG. 1 is a perspective view of a locomotive, according to an embodiment of the present disclosure.

FIG. 2 is a block diagram of a hybrid propulsion system in the locomotive of FIG. 1, according to an embodiment of the present disclosure.

FIG. 3 is diagram of the locomotive of FIG. 1 approaching a geofence area, according to one embodiment of the disclosure.

FIG. 4 is a graph depicting locomotive power vs Handle Notch for the Locomotive of FIG. 1, according to an embodiment of the present disclosure.

FIG. 5 is a flow-chart of an operation of the hybrid propulsion system of FIG. 2 according to an embodiment of the present disclosure.

FIG. 6 is a flow-chart of a method of hybrid boost propulsion of the locomotive of FIG. 1, according to an embodiment of the present disclosure.

The figures depict one embodiment of the presented invention for purposes of illustration only. One skilled in the art will readily recognize from the following discussion that alternative embodiments of the structures and methods illustrated herein may be employed without departing from the principles described herein.

### DETAILED DESCRIPTION

Referring now to the drawings, and with specific reference to the depicted example, a locomotive 100 is shown, illustrated as an exemplary train. Locomotives are vehicles designed to transport goods and materials across railways. While the following detailed description describes an exemplary aspect in connection with the train, it should be appreciated that the description applies equally to the use of the present disclosure in other locomotives, including, but not limited to, trains, hybrid locomotives, and hybrid trains, as well.

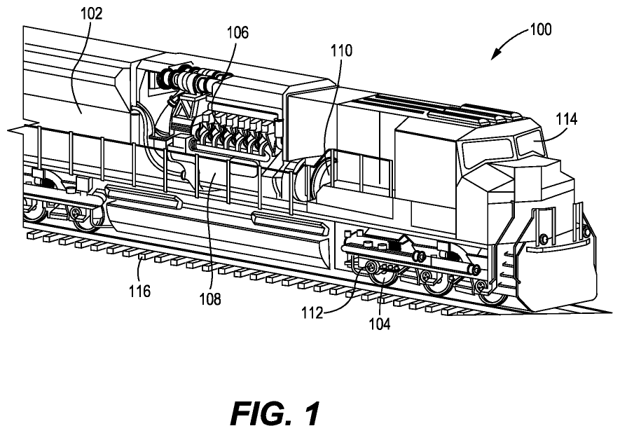

Referring now to FIG. 1, the locomotive 100 comprises a frame 102. The frame 102 is supported on ground engaging elements 104, illustrated as continuous tracks. It should be contemplated that the ground engaging elements 104 may be any other type of ground engaging elements 104 such as, for example, wheels, etc. The locomotive 100 further includes a prime mover 106 in the frame 102, a battery 108, a transmission 110 for converting mechanical energy from the prime mover 106 to drive the ground engaging elements 104, a transmission 110 associated with the prime mover 106, a traction motor 112 for converting electrical energy into mechanical energy to drive the ground engaging elements 104, and a cab 114 for operator personnel to operate the locomotive 100.

The prime mover 106 may be an internal combustion engine serving as the primary source of locomotive power, as generally known in the arts. The prime mover 106 may use diesel or gasoline as fuel. The use of an internal combustion engine as the prime mover 106 may provide the locomotive 100 with required necessary power and torque to handle various loads and terrains. The prime mover 106 converts fuel and air into mechanical energy, propelling the locomotive 100 and facilitating its movement along railway tracks 116.

The traction motor 112 may convert electrical power, sourced from the battery 108, into mechanical power to boost the tractive power of the ground engaging elements 104 moving along the railway tracks 116. This mechanical power generated by the traction motor 112 may be utilized to drive the ground engaging elements 104 of the locomotive 100, providing the necessary torque for movement and speed control. In diesel-electric locomotives, the traction motor 112 may also receive power from the prime mover 106 associated with a generator.

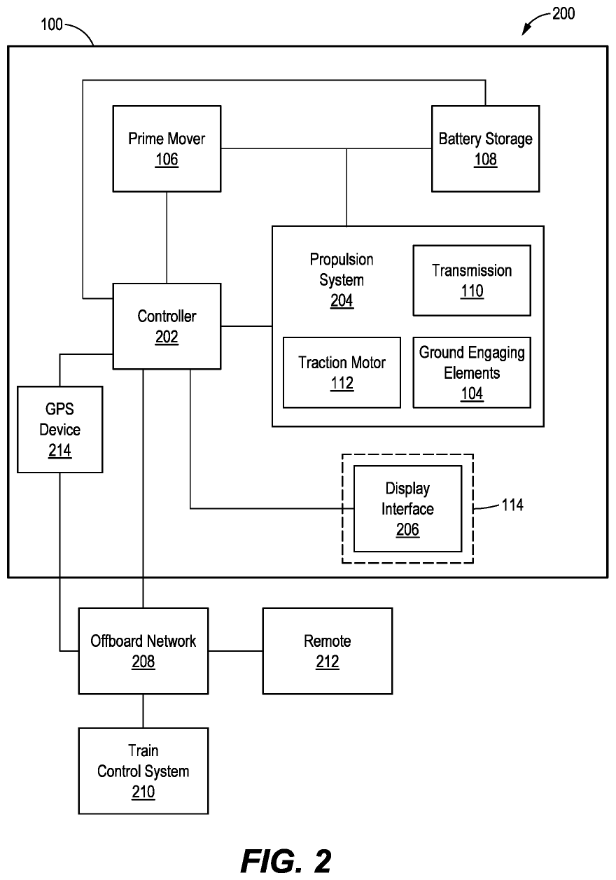

Now referring to FIG. 2, a block diagram of a hybrid propulsion system 200 is illustrated, according to one embodiment of the disclosure. The hybrid propulsion system 200 for the locomotive 100 comprises the prime mover 106, the battery 108, a controller 202, and a propulsion system 204. The propulsion system 204 includes a transmission 110 and the ground engaging elements 104. The controller 202 may be further connected to a display interface 206, an off-board network 208, a train control system 210, and a remote 212. The controller 202 may be connected to a GPS device 214 (global positioning system).

The hybrid propulsion system 200 controls the power supply to the locomotive 100 based on the location of the locomotive 100, as detected by the controller 202. The controller 202 may be a central processing unit (CPU) that controls the overall operation of the hybrid propulsion system 200 of the locomotive 100. The controller 202 may include any general-purpose processor known in the art.

The controller 202 in the locomotive 100 may control operational systems associated with the locomotive 100. The operational systems may be one of many operating systems found within a locomotive 100 such as an ignition system, a fuel injection system, an oil transport system, the transmission 110, a throttle system, a power system, a braking system, a cooling system, a navigation system, a lighting system, an alarm system, a battery system, and/or an engine or other propulsion system, as generally known in the arts. These systems may also include one or more hydraulic, mechanical, electronic, and software-based components in which the controller 202 may communicate with and control, as generally known in the arts. The remote 212 may be used to communicate with the controller 202, via the off-board network 208, to control, activate, or deactivate the operational systems and the boost mode for the locomotive 100.

The battery 108 is onboard the locomotive 100 and may be a rechargeable battery, such as a lead-acid battery, a lithium-ion battery, or a nickel-metal hydride battery. The battery 108 is adapted to supply power to the locomotive 100. The battery 108 may be operable to store regenerative power, as may be generated by the locomotive 100 while the locomotive 100 is in motion. Regenerative power, which is generally produced by a regenerative braking system (not shown) during braking of the locomotive 100, may be fed back to the battery 108 for charging the battery 108.

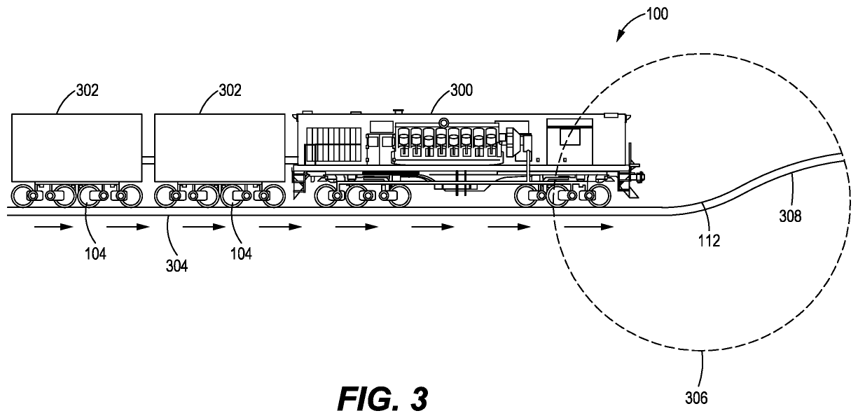

FIG. 3 is a diagram of the locomotive 100 traveling on the railway tracks 116, according to one embodiment of the disclosure. The locomotive 100 may have a pilot locomotive 300 and a plurality of second locomotives 302 traveling on a route 304. The train control system 210, such as North America's PTC, may provide both the characteristics and makeup of the locomotive 100, such as the train consist, the route 304, and a topography of the route 304, including a geofence area 306. The geofence area 306 may be an elevated terrain 308. The geofence area 306 may be a critical grade area with steep elevations requiring additional power boost to the locomotive 100 for traversing the critical grade areas.

When the locomotive 100 approaches or enters the geofence area 306, the controller 202 may signal the battery 108 to discharge electric energy to the traction motor 112 to provide a boost of additional power to the ground engaging elements 104 beyond what the prime mover 106 provides to the propulsion system 204.

The controller 202 in the hybrid propulsion system 200 is configured to manage a supply of power to the locomotive, based on the location of the locomotive 100 on the route 304. The controller 202 determines the location of the locomotive 100 with respect to the geofence area 306, via the train control system 210 and/or the GPS device 214. Subsequently, the hybrid propulsion system 200 controls the power supply to the locomotive 100 by boosting the power supply to the propulsion system 204 when at, near, or in a geofence area 306.

The GPS device 214 is configured to detect the location of the locomotive 100. The GPS device 214 determines a global position of the locomotive 100 in the form of latitude and longitude. Based on the global position, the controller 202 detects when the locomotive 100 enters the geofence area 306 and when the locomotive 100 leaves the geofence area 306. The display interface 206 is in operable communication with the controller 202. The display interface 206 is configured to receive and display location data from the controller 202, via the GPS device 214. The location data includes the location of the locomotive 100 with respect to the route 304 and the geofence area 306.

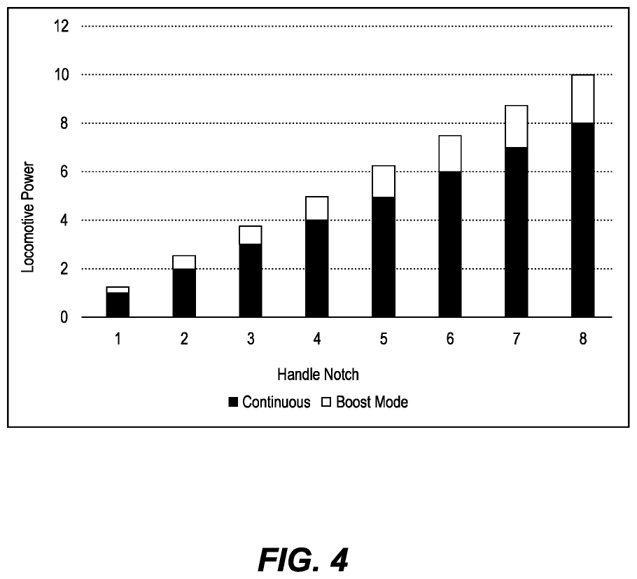

Now referring to FIG. 4, a graph depicting the power of the locomotive 100 versus a Handle Notch for the Locomotive 100 of FIG. 1, according to an embodiment of the present disclosure. While in or near the geofence area 306, the hybrid propulsion system 200 activates a “boost mode” to increase the power provided to the ground engaging elements 104 of the locomotive 100. In boost mode, the locomotive 100's prime mover 106 may operate simultaneously with discharging the electric energy in the battery 108 to boost the locomotive 100. This combination allows the locomotive 100 to produce tractive force beyond the capabilities of its prime mover 106.

The locomotive 100 may have a plurality of power settings, often referred to as “notches”, each of which has an associated maximum constant power. For example, the locomotive may have nine notches which include: Idle (unpowered)+N1 through N8. The boost mode proportionally increases the per-notch power so that the engineer's perception of the locomotive 100 driving is altered to the minimum degree possible. For example, when the locomotive 100 enters the geofence area 306, which may be a geofenced area, the locomotive 100 may remain in Notch 8 for the entirety of the geofenced area.

In case maneuvering is required for locomotive-handling purposes, the operator of the locomotive 100 may be provided with intuitive, transparent control interface, via the display interface 206, of the locomotive 100 while enabling it to traverse portions of the railway tracks 116 on the route 304 that are beyond its continuous power rating. The display interface 206 may include features which indicate the state of the boost mode. The display interface 206 may also be configured to display features that indicate of the state of the boost mode, as well as providing other display features such as a “gas gauge” or countdown display of the remaining energy in the battery 108 for the operator's benefit. The display interface 206 may also provide real time GPS location displays on the display interface 206 and may be further configured to alert an operator when the locomotive 100 enters the geofence area 306. The display interface 206 may be provided in cab 114 and allow manually selection on the display interface 206 to activate or deactivate the boost mode, manually, when entering or leaving the geofence area 306.

The geofence area 306 may be transmitted to the controller 202 by PTC, the GPS device 214, or a back-office system, via the off-board network 208, to the pilot locomotive 300. The pilot locomotive 300 may communicate with the plurality of second locomotives 302 in the consist. When entering (or leaving) the geofence area 306, the pilot locomotive 300 transmits, via the controller 202, a “boost mode status” message to a second controller in the plurality of second locomotives 302 so that they all behave uniformly.

The locomotive 100 may be connected to a plurality of second locomotives, each locomotive having a second battery, second ground engaging elements, and a second controller. The controller 202 may be in further communication with the second controller. The controller 202 may activate the boost mode simultaneously to with the second controller to consume a second electric energy stored in the second battery in each second locomotive to boost a tractive force of the second ground engaging elements in uniform with the ground engaging elements 104 of the locomotive 100.

### INDUSTRIAL APPLICABILITY

In operation, the present disclosure may find applicability in many industries including, but not limited to, the railroad industry. Specifically, the systems, machines, and methods of the present disclosure may be used for propulsion systems of other locomotives and work machines including, but not limited to, trains, trucks, and marine vessels, excavators, backhoes, rope shovels, skid steers, wheel loaders, tractors, and similar locomotives utilizing combustion engines. While the foregoing detailed description is made with specific reference to trains, it is to be understood that its teachings may also be applied to other locomotives. The hybrid propulsion system 200 may be provided as a retrofit onto these other applications.

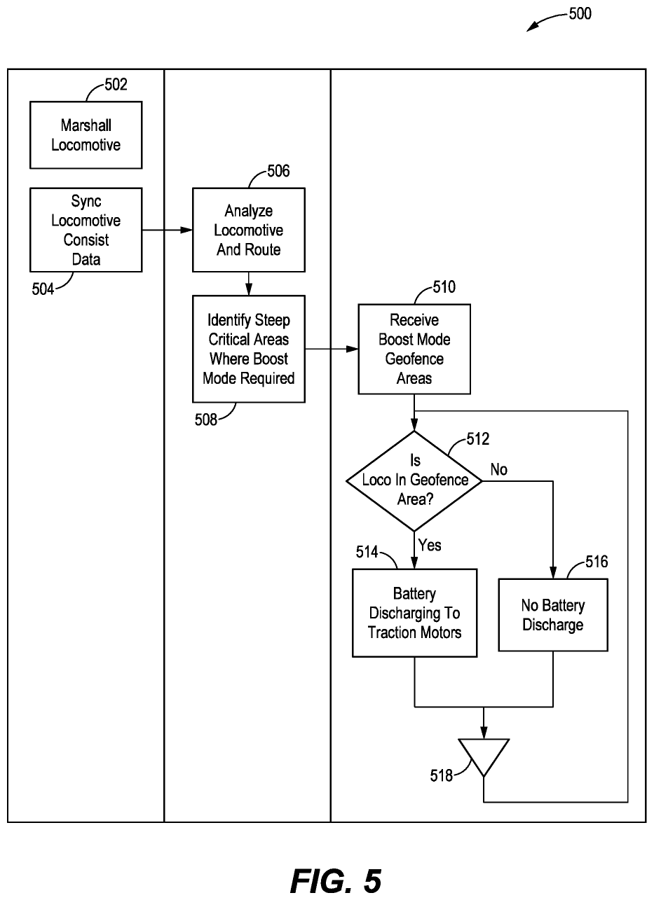

Now referring to FIG. 5, a flow-chart of an operation 500 of the hybrid propulsion system 200 of FIG. 2, according to an embodiment of the present disclosure. The hybrid propulsion system 200 allows the locomotive 100 to operate efficiently by determining where additional power is required or needed using reserve battery power for improved power efficiency.

In a step 502, the locomotive 100 may be marshalled by the railway. In a step 504, the controller 202 may sync locomotive consist data of the locomotive 100 with the off-board network 208. In a step 506, the controller 202 may analyze the locomotive 100 and the route 304. In a step 508, the controller 202 may identify the geofence areas 306, such as steep areas where the boost mode may be required, and/or beneficial for efficient use.

In a step 510, the controller 202 receives the route data of the geofence area 306 for when to activate the boost mode. In a step 512, the controller 202 determines if the locomotive 100 is in the geofence area 306. In a step 514, the controller 202 may determine the locomotive 100 is in the geofence area 306 and activate the boost mode. The battery 108 may be discharged to supply a proportional amount of supplemental energy to the current handle notch in which the locomotive 100 is operating for an additional power boost while moving in the geofence area 306.

If the locomotive 100 is determined not to be in the geofence area 306, then energy stored in the battery 108 will not be discharged. In step 518, the controller 202 returns to continuously monitoring the location of the locomotive 100 and whether it enters the geofence area 306 for efficiently activating the boost mode.

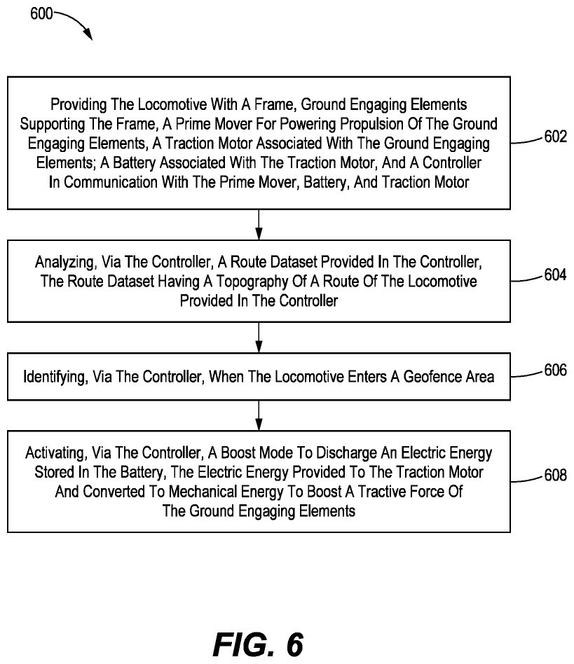

Now referring to FIG. 6, a flow-chart of a method 600 hybrid propulsion of the locomotive 100 is illustrated, according to an embodiment of the present disclosure. In a step 602, the locomotive 100 is provided with the frame 102, ground engaging elements 104 supporting the frame 102, the prime mover 106 for powering propulsion of the ground engaging elements 104, the traction motor 112 associated with the ground engaging elements 104, the battery 108 associated with the traction motor 112, and the controller 202 in communication with the prime mover 106, battery 108, and the traction motor 112. In a step 604, the controller 202 analyzes the topography of the route 304 and location of the locomotive 100 from a route dataset provided to the controller 202. The route dataset may have a topography of the route 304 of the locomotive 100 and may be continuously updated via the GPS device 214 for accurate topography and location status.

In a step 606, the controller 202 identifies when the locomotive 100 enters the geofence area 306. In a step 608, the controller 202 activates the boost mode to discharge electric energy stored in the battery 108 to the traction motor 112. The electric energy provided to the traction motor 112 is converted to mechanical energy which is transferred to the ground engaging elements 104 to boost the tractive force of the ground engaging elements 104 on the railway tracks 116.

From the foregoing, it can be seen that the technology disclosed herein has industrial applicability in the fields of locomotives for improving propulsion of locomotives and freight vehicles with hybrid combustion engines.

What is claimed is:

1. A hybrid propulsion system for a locomotive, the hybrid propulsion system comprising:
ground engaging elements associated with the locomotive;
a prime mover for powering propulsion of the ground engaging elements;
a traction motor associated with the ground engaging elements;
a battery associated with the traction motor;
a controller including a route dataset having a topography of a route of the locomotive, the controller configured to:
analyze the topography of the route and location of the locomotive;
identify when the locomotive enters a geofence area; and
activate a boost mode to discharge an electric energy stored in the battery to the traction motor to boost a tractive force of the ground engaging elements.

2. The hybrid propulsion system of claim 1, further comprising a display interface in communication with the controller for manually selecting the activation or deactivation of the boost mode.

3. The hybrid propulsion system of claim 1, further comprising:
the locomotive being connected to a plurality of second locomotives, each locomotive having a second battery, second ground engaging elements, and a second controller; and
the controller is further configured to communicate the boost mode simultaneously with the second controller to consume a second electric energy stored in the second battery in each second locomotive to boost a tractive force of the second ground engaging elements in uniform with the ground engaging elements of the locomotive.

4. The hybrid propulsion system of claim 1, further comprising an off-board network and a remote in communication with the controller, wherein the off-board network continuously updates the controller in real time.

5. The hybrid propulsion system of claim 1, wherein the locomotive is a train and the prime mover is a diesel engine.

6. The hybrid propulsion system of claim 1, wherein the route dataset includes characteristics of the locomotive, the route of the locomotive, and the topography of the route.

7. The hybrid propulsion system of claim 1, further comprising a GPS device in communication with the controller, the GPS device providing real-time location of the locomotive.

8. A hybrid locomotive comprising:
a frame;
ground engaging elements supporting the frame;
a prime mover for powering propulsion of the ground engaging elements, the prime mover mounted in the frame;
a battery associated with the prime mover and mounted in the frame;
a controller including a route dataset having a topography of a route of the hybrid locomotive, the controller configured to:
analyze the topography of the route and location of the hybrid locomotive;
identify when the hybrid locomotive enters a geofence area; and
activate a boost mode to discharge an electric energy stored in the battery to the traction motor to boost a tractive force of the ground engaging elements.

9. The hybrid locomotive of claim 8, further comprising a display interface in a cab of the hybrid locomotive in communication with the controller for manually selecting the activation or deactivation of the boost mode.

10. The hybrid locomotive of claim 8, further comprising:
the locomotive being connected to a plurality of second locomotives, each locomotive having a second battery, second ground engaging elements, and a second controller; and
the controller is further configured to communicate the boost mode simultaneously with the second controller to consume a second electric energy stored in the second battery in each second locomotive to boost a tractive force of the second ground engaging elements in uniform with the ground engaging elements of the locomotive.

11. The hybrid locomotive of claim 8, further comprising an off-board network and a remote in communication with the controller, wherein the off-board network continuously updates the controller in real time.

12. The hybrid locomotive of claim 8, wherein the hybrid locomotive is a train and the prime mover is a diesel engine.

13. The hybrid locomotive of claim 8, wherein the train control system includes characteristics of the hybrid locomotive, the route of the hybrid locomotive, and the topography of the route.

14. The hybrid locomotive of claim 8, further comprising a GPS device in communication with the controller, the GPS device providing real-time location of the hybrid locomotive.

15. A method for hybrid propulsion of a locomotive, the method comprising:
providing the locomotive with a frame, ground engaging elements supporting the frame, a prime mover for powering propulsion of the ground engaging elements, a traction motor associated with the ground engaging elements, a battery associated with the traction motor, and a controller in communication with the prime mover, the battery, and the traction motor;
analyzing, via the controller, a route dataset provided in the controller, the route dataset having the topography of the route of the locomotive provided in the controller;
identifying, via the controller, when the locomotive enters a geofence area; and
activating, via the controller, a boost mode to discharge an electric energy stored in the battery, the electric energy provided to the traction motor and converted to mechanical energy to boost a tractive force of the ground engaging elements.

16. The method of claim 15, the method further comprising:
selecting manually, via a display interface in communication with the controller, the activation or deactivation of the boost mode.

17. The method of claim 15, the method further comprising:
connecting the locomotive to a plurality of second locomotives, each locomotive having a second battery, second ground engaging elements, and a second controller;
activating, via the controller in further communication with the second controller, the boost mode simultaneously with the second controller to consume a second electric energy stored in the second battery in each second locomotive to boost a tractive force of the second ground engaging elements in uniform with the ground engaging elements of the locomotive.

18. The method of claim 15, the method further comprising:
providing an off-board network and a remote in communication with the controller, wherein the off-board network continuously updates the controller in real-time.

19. The method of claim 15, the method further comprising:
providing characteristics of the locomotive, the route of the locomotive, and the topography of the route in the route dataset.

20. The method of claim 15, the method further comprising:
providing a GPS device in communication with the controller, the GPS device providing real-time location of the locomotive.
